(19) United States
(12) Patent Application Publication
(10) Pub. No.: US 2023/0416545 A1
(43) Pub. Date: Dec. 28, 2023

(54) AQUEOUS PIGMENT INK FOR TEXTILE INKJET PRINTING, AND METHOD FOR PRODUCING PRINTED TEXTILE ITEM

(71) Applicant: RISO KAGAKU CORPORATION, Tokyo (JP)

(72) Inventors: Takahisa YAMAZAKI, Tokyo (JP); Masanori ITO, Tokyo (JP); Takeshi KOYAMA, Tokyo (JP)

(21) Appl. No.: 18/336,602

(22) Filed: Jun. 16, 2023

(30) Foreign Application Priority Data
Jun. 28, 2022 (JP) 2022-103702

(51) Int. Cl. C09D 11/322; C09D 11/037; C09D 11/033; D06P 5/30; B41J 3/407

(52) U.S. Cl. CPC C09D 11/322; C09D 11/037; C09D 11/033; D06P 5/30; B41J 3/4078

(57) ABSTRACT

Provided is an aqueous pigment ink for textile inkjet printing, including a pigment, a water-dispersible resin, water, and a water-soluble organic solvent, wherein an ink film made by drying the aqueous pigment ink for textile inkjet printing has a weight change ratio of 20% or less between before and after immersion in warm water at 50° C., and has a film elongation of 50% to 300% after immersion in warm water at 50° C. Also provided is a method for producing a printed textile item.

### CROSS REFERENCE TO RELATED APPLICATIONS

This application is based upon and claims the benefit of priority from the prior Japanese Patent Application No. 2022-103702, filed on Jun. 28, 2022, the entire contents of which are incorporated by reference herein.

### BACKGROUND OF THE INVENTION

### Field of the Invention

Embodiments of the present invention relate to an aqueous pigment ink for textile inkjet printing, and a method for producing a printed textile item.

### Description of the Related Art

Among the various methods for printing images such as text, pictures, or designs onto fabrics such as woven fabrics, knitted fabrics, and nonwoven fabrics, inkjet textile printing according to a direct method using a pigment ink is now attracting considerable attention.

In textile printing, washing fastness is required as well as color development of images.

For techniques to improve fastness to washing, JP 2013-71957A discloses a method using an ink and a coating liquid different from the ink, and JP 2019-31611A discloses an ink containing a resin having a high elongation at break of 1200% to 1800% and a small amount of a crosslinking agent.

### SUMMARY OF THE INVENTION

One embodiment of the present invention relates to an aqueous pigment ink for textile inkjet printing including a pigment, a water-dispersible resin, water, and a water-soluble organic solvent, wherein an ink film made by drying the aqueous pigment ink for textile inkjet printing has a weight change ratio of 20% or less between before and after immersion in warm water at 50° C., and has a film elongation of 50% to 300% after immersion in warm water at 50° C.

Another embodiment of the present invention relates to a method for producing a printed textile item including applying the aqueous pigment ink for textile inkjet printing according to one embodiment described above to a fabric using an inkjet method.

### DETAILED DESCRIPTION OF THE EMBODIMENTS

Embodiments of the present invention are described below in detail, but needless to say, the present invention is not limited to these embodiments, and various modifications and alterations are possible.

An aqueous pigment ink for textile inkjet printing according to one embodiment includes a pigment, a water-dispersible resin, water, and a water-soluble organic solvent, wherein an ink film made by drying the aqueous pigment ink for textile inkjet printing has a weight change ratio of 20% or less between before and after immersion in warm water at 50° C., and has a film elongation of 50% to 300% after immersion in warm water at 50° C.

Hereinafter, “aqueous pigment ink for textile inkjet printing” may be simply referred to as “ink” or “aqueous ink”.

After careful study by the inventors to provide an aqueous pigment ink for textile inkjet printing for producing a printed textile item having excellent fastness to washing, it was found that when an ink film produced by drying the ink was immersed in water, the weight and the film elongation of the ink film can change, and moreover, it was found that the weight change ratio of the ink film between before and after immersion in water and the film elongation of the ink film after immersion in water are significantly related to the washing fastness of the printed textile item that has been printed using the ink.

Especially, using warm water at 50° C. as water to immerse the ink film can increase the correlation between the weight change ratio of the ink film between before and after immersion in water and the washing fastness of the printed textile item that has been printed, and the correlation between the film elongation of the ink film after immersion in water and the washing fastness of the printed textile item that has been printed. Although not bound by any particular theory, the reason is presumed to be that bringing warm water at 50° C. into contact with the ink film can cause the resin molecular structure and bonding state of the ink film to be close to those of the film when the actual washing fastness is evaluated.

When the weight of the ink film increases after warm water immersion at 50° C., it is thought that water has penetrated the ink film and/or the ink film has changed in quality due to water. In the former case, it is suggested that the density of the ink film is low, and it is thought that the ink film is more likely to be destroyed by an external force during washing. In the latter case, it is thought that through repeated washing, the ink film degrades and is likely to be destroyed. For these reasons, from the viewpoint of washing fastness, it is preferable that the weight change ratio of the ink film between before and after immersion in warm water at 50° C. be small, preferably 20% or less.

When the film elongation of the ink film after immersion in warm water at 50° C. is 50% or more, it is thought that the ink film can easily follow the elongation of a fabric during washing and the ink film is less likely to be destroyed by an external force. Meanwhile, in general, resins tend to have a lower elastic force, that is, tend to have a lower force to return to its original length when stretched, as the film elongation increases. However, when the film elongation of the ink film after immersion in warm water at 50° C. is 300% or less, the ink film can ensure a sufficient elastic force to withstand the stretching of a fabric during washing and the ink film is thought to be less likely to be destroyed.

As described above, when the weight change ratio between before and after immersion in warm water at 50° C. of the ink film produced by drying the ink is 20% or less, and the film elongation after immersion in warm water at 50° C. of the ink film is 50% or more and 300% or less, good washing fastness can be achieved.

The aqueous pigment ink for textile inkjet printing can contain a pigment as a colorant.

Pigments which can be used include organic pigments such as azo pigments, phthalocyanine pigments, polycyclic pigments, and dye lake pigments, and inorganic pigments such as carbon blacks and metal oxides.

Examples of azo pigments include soluble azo lake pigments, insoluble azo pigments, and condensed azo pigments. Examples of phthalocyanine pigments include metal phthalocyanine pigments and metal-free phthalocyanine pigments. Examples of polycyclic pigments include quinacridone-based pigments, perylene-based pigments, perinone-based pigments, isoindoline-based pigments, isoindolinone-based pigments, dioxazine-based pigments, thioindigo-based pigments, anthraquinone-based pigments, quinophthalone-based pigments, metal complex pigments, and diketopyrrolopyrroles (DPP). Examples of carbon blacks include furnace carbon black, lamp black, acetylene black, and channel black. Examples of metal oxides include titanium dioxide and zinc oxide.

These pigments may be used alone, or a combination of two or more may be used.

From the viewpoints of jetting stability and storage stability, the average particle size of the pigment particles in the ink, expressed as the volume-based average value in a particle size distribution measured by a dynamic light-scattering method, is preferably 300 nm or less, more preferably 150 nm or less, and even more preferably 100 nm or less. From the viewpoints of print density and ink viscosity, the amount of the pigment relative to the total mass of the ink is preferably within a range from 0.1 to 15% by mass, more preferably 1 to 15% by mass, and even more preferably 2 to 10% by mass.

A self-dispersing pigment may be blended as the pigment. A self-dispersing pigment is a pigment in which a hydrophilic functional group has been introduced into the surface of the pigment through a chemical or a physical treatment. The hydrophilic functional group to be introduced into the self-dispersing pigment is preferably ionic, and the pigment particles can be stably dispersed in water by an electrostatic repulsion force by anionically or cationically charging the surface of the pigment. Examples of preferable anionic functional groups include carboxyl groups, sulfo groups, and phosphoric acid groups. Examples of preferable cationic functional groups include quaternary ammonium groups and quaternary phosphonium groups.

These hydrophilic functional groups may be bonded directly to the pigment surface or may be bonded via other atom groups. Examples of other atom groups include, but are not limited to, alkylene groups, phenylene groups, and naphthylene groups. Examples of the pigment surface treatment method include a diazotization treatment, a sulfonation treatment, a hypochlorous acid treatment, a humic acid treatment, and a vacuum plasma treatment.

Preferable examples of the self-dispersing pigment include “CAB-O-JET 200”, “CAB-O-JET 300”, “CAB-O-JET 250C”, “CAB-O-JET 260M”, and “CAB-O-JET 270”, “CAB-O-JET 400”, and “CAB-O-JET 450C” of the CAB-O-JET series manufactured by Cabot Corporation, and “BONJET BLACK CW-1”, “BONJET BLACK CW-2”, “BONJET BLACK CW-3”, and “BONJET BLACK CW-4” manufactured by Orient Chemical Industries Co., Ltd. (all trade names).

As a pigment, a microencapsulated pigment obtained by coating the pigment with a resin may be used.

A pigment dispersion in which a pigment has been dispersed in advance with a pigment dispersant may be used. Examples of commercially available pigment dispersions in which a pigment has been dispersed with a pigment dispersant include the HOSTAJET series manufactured by Clariant and the FUJI SP series manufactured by Fuji Pigment Co., Ltd. A pigment dispersion in which a pigment has been dispersed with a pigment dispersant described below may be used.

A pigment dispersant typified by polymeric dispersants and surfactant-type dispersants may be preferably used for the pigment to be stably dispersed in the ink.

Examples of commercially available polymeric dispersants include “TEGO Dispers 740W”, “TEGO Dispers 750W”, “TEGO Dispers 755W”, “TEGO Dispers 757W”, and “TEGO Dispers 760W” of the TEGO Dispers series manufactured by Evonik Industries AG, “Solsperse 20000”, “Solsperse 27000”, “Solsperse 41000”, “Solsperse 41090”, “Solsperse 43000”, “Solsperse 44000”, and “Solsperse 46000” of the Solsperse series manufactured by The Lubrizol Corporation, “Joncryl 57”, “Joncryl 60”, “Joncryl 62”, “Joncryl 63”, “Joncryl 71”, and “Joncryl 501” of the Joncryl series manufactured by BASF Japan Ltd., “DISPERBYK-102”, “DISPERBYK-185”, “DISPERBYK-190”, “DISPERBYK-193”, and “DISPERBYK-199” manufactured by BYK-Chemie Japan K.K., and “Polyvinylpyrrolidone K-30” and “Polyvinylpyrrolidone K-90” manufactured by DKS Co. Ltd. (all trade names).

Examples of surfactant-type dispersants include anionic surfactants such as “DEMOL P”, “DEMOL EP”, “DEMOL N”, “DEMOL RN”, “DEMOL NL”, “DEMOL RNL”, and “DEMOL T-45” of the DEMOL series manufactured by Kao Corporation, and nonionic surfactants such as “EMULGEN A-60,” “EMULGEN A-90”, “EMULGEN A-500”, “EMULGEN B-40”, “EMULGEN L-40”, and “EMULGEN 420” of the EMULGEN series manufactured by Kao Corporation (all trade names).

One pigment dispersant may be used, or a combination of two or more may be used.

When a pigment dispersant is used, there are no particular limitations on the amount of the pigment dispersant in the ink, which may vary depending on the type of pigment dispersant used, and in general, the amount of the pigment dispersant, expressed as a mass ratio of the active ingredient relative to a value of 1 for the pigment, is preferably within a range from 0.005 to 0.5.

The aqueous pigment ink for textile inkjet printing can contain a water-dispersible resin.

The water-dispersible resin is preferably composed of resin particles that can be dispersed in an aqueous solvent. The water-dispersible resin can, for example, be blended into the ink in the form of an oil-in-water resin emulsion.

The water-dispersible resin may be a self-emulsifying resin having an introduced hydrophilic group and/or hydrophilic segment that enables stable dispersion in water, or may be a resin having water-dispersibility through use of a separate emulsifier.

The water-dispersible resin may be an anionic water-dispersible resin, a cationic water-dispersible resin, a nonionic water-dispersible resin, or an amphoteric water-dispersible resin. For example, an anionic water-dispersible resin, a nonionic water-dispersible resin, or a combination thereof can be preferably used as the water-dispersible resin.

From the viewpoint of inkjet jetting characteristics, the average particle size of the water-dispersible resin is preferably 600 nm or less, more preferably 300 nm or less, and even more preferably 200 nm or less. For example, the average particle size of the resin particles may be in a range of 10 to 600 nm, may be in a range of 50 to 300 nm, or may be in a range of 50 to 200 nm. The average particle size of the water-dispersible resin is the volume-based average particle size obtained using a dynamic light scattering method.

In terms of the type of water-dispersible resin, it is preferable to use a resin that forms a transparent film.

Examples of the water-dispersible resin include conjugated diene-based resins such as styrene-butadiene copolymers, methyl methacrylate-butadiene copolymers, and vinyl chloride-vinyl acetate copolymers; acrylic-based resins such as acrylate ester polymers, methacrylate ester polymers, and copolymers of any of these compounds with styrene or the like; vinyl-based resins such as ethylene-vinyl acetate copolymers; functional group-modified resins in which any of these resins has been modified with a monomer containing a functional group such as a carboxyl group; melamine resins; urea resins; polyurethane resins; polyester resins; polyolefin resins; silicone resins; polyvinyl butyral resins; and alkyd resins. A resin emulsion containing one of these resins may be used, and a hybrid resin emulsion may also be used.

Among these water-dispersible resins, for example, an acrylic-based resin, a polyurethane resin, or a combination thereof can be preferably used.

The polyurethane resin may be either aliphatic polyurethane or aromatic polyurethane. Examples of the polyurethane resin include ether-based polyurethane resins, ester-based polyurethane resins, ester-ether-based polyurethane resins, and carbonate-based polyurethane resins.

One of these water-dispersible resins may be used alone, but it is preferable to use a combination of two or more from the viewpoint of the ease of obtaining desired ink film characteristics.

The ink preferably contains at least two water-dispersible resins selected from the group consisting of water-dispersible acrylic-based resins and water-dispersible polyurethane resins. For example, a plurality of water-dispersible polyurethane resins may be used in combination, or a water-dispersible acrylic-based resin and a water-dispersible polyurethane resin may be used in combination.

The glass transition temperature of the water-dispersible resin is not particularly limited.

The glass transition temperature of the water-dispersible resin is, for example, preferably 150° C. or lower, more preferably 100° C. or lower, and even more preferably 80° C. or lower. The glass transition temperature of the water-dispersible resin is preferably −50° C. or higher, more preferably −40° C. or higher, and even more preferably −30° C. or higher. The glass transition temperature of the water-dispersible resin is, for example, preferably within a range from −50 to 150° C., more preferably −40 to 100° C., and even more preferably −30 to 80° C.

The ink preferably contains two or more water-dispersible resins having different glass transition temperatures. For example, the ink preferably contains a water-dispersible resin having a glass transition temperature of 15° C. or higher and a water-dispersible resin having a glass transition temperature of less than 15° C.

The glass transition temperature of a water-dispersible resin having a glass transition temperature of 15° C. or higher is more preferably 20° C. or higher, and even more preferably 30° C. or higher. The glass transition temperature of a water-dispersible resin having a glass transition temperature of 15° C. or higher is, for example, more preferably within a range from 15 to 150° C., even more preferably 20 to 100° C., and even more preferably 30 to 80° C.

The glass transition temperature of a water-dispersible resin having a glass transition temperature of less than 15° C. is more preferably 14° C. or lower, even more preferably 10° C. or lower, and even more preferably 5° C. or lower. The glass transition temperature of a water-dispersible resin having a glass transition temperature of less than 15° C., for example, is more preferably within a range from −50 to less than 15° C., even more preferably −50 to 14° C., even more preferably −40 to 10° C., and even more preferably −30 to 5° C.

In the present disclosure, the glass transition temperature (Tg) of a resin can be measured according to differential scanning calorimetry (DSC).

The film elongation of the water-dispersible resin is not particularly limited.

The film elongation of the water-dispersible resin is preferably 1% or more, more preferably 2% or more, and even more preferably 5% or more. The film elongation of the water-dispersible resin is preferably 1800% or less, more preferably 1700% or less, and even more preferably 1600% or less. The film elongation of the water-dispersible resin is preferably within a range from 1 to 1800%, more preferably 2 to 1700%, and even more preferably 5 to 1600%, for example.

The ink preferably contains two or more water-dispersible resins having different film elongations.

For example, the ink preferably contains a water-dispersible resin having a film elongation of 400% or more and a water-dispersible resin having a film elongation of less than 400%.

The film elongation of a water-dispersible resin having a film elongation of 400% or more is more preferably 500% or more, even more preferably 600% or more, and even more preferably 700% or more. The film elongation of a water-dispersible resin having a film elongation of 400% or more, for example, is more preferably within a range from 400 to 1800%, even more preferably 500 to 1700%, even more preferably 600 to 1700%, and even more preferably 700 to 1600%.

The film elongation of a water-dispersible resin having a film elongation of less than 400% is more preferably 300% or less, even more preferably 250% or less, even more preferably 200% or less, even more preferably 150% or less, and even more preferably 100% or less. The film elongation of a water-dispersible resin having a film elongation of less than 400%, for example, is preferably within a range from 1 to less than 400%, more preferably 1 to 300%, even more preferably 2 to 250%, even more preferably 2 to 200%, even more preferably 2 to 150%, and even more preferably 5 to 100%.

Here, the film elongation of the water-dispersible resin can be measured according to the following procedure.

First, an aqueous resin emulsion of the water-dispersible resin is applied on a polytetrafluoroethylene sheet in an amount sufficient to achieve a dried film thickness of 500 μm, the applied resin is then dried at 23° C. for 15 hours, then at 80° C. for 6 hours, and then at 120° C. for 20 minutes, and the resulting film is then detached from the sheet to produce a resin film. The resin film is punched out using a dumbbell-type test piece punching blade No. 8 according to JIS K6251 to produce a test piece.

Using a tensile tester, under the conditions of a measurement temperature of 20° C., a measurement speed of 500 mm/min, a chuck separation distance of 20 mm, and a load cell load of 50N, a test piece produced as described above is stretched and the length L_{RF} to which the test piece is stretched until the test piece breaks (also referred to as the “test piece length after stretching”) is measured, and using the length L_{RF0} of the test piece before stretching and the length L_{RF} of the test piece after stretching, the film elongation (%) can be obtained using the following equation.

Film elongation (%)={(L_{RF}−L_{RF0})/L_{RF0}}×100

As the tensile tester, a Tensilon Universal Tester RTC-1225A (manufactured by Orientec Co., Ltd.) can be used.

Examples of commercially available products of aqueous resin emulsions of water-dispersible resins include “SUPERFLEX 500M” and “SUPERFLEX 460” manufactured by DKS Co., Ltd., “DAOTAN TW6493/35WA” manufactured by DaicelAllnex Ltd., “ADEKA BONTIGHTER HUX-2520” and “ADEKA BONTIGHTER HUX-841” manufactured by ADEKA Corporation, and “NeoCryl XK-12” manufactured by Covestro AG (all trade names).

One water-dispersible resin may be used alone, but it is more preferable to use a combination of two or water-dispersible resins.

The amount of the water-dispersible resin is, relative to the total mass of the ink, preferably 1% by mass or more, more preferably 2% by mass or more, and even more preferably 3% by mass or more. The amount of the water-dispersible resin is, relative to the total mass of the ink, preferably 25% by mass or less, more preferably 20% by mass or less, even more preferably 15% by mass or less, and even more preferably 12% by mass or less. The water-dispersible resin is, relative to the total mass of the ink, preferably within a range from 1 to 25% by mass, more preferably 1 to 20% by mass, even more preferably 2 to 15% by mass, and even more preferably 3 to 12% by mass, for example.

When the ink contains two or more water-dispersible resins having different film elongations, the mass ratio of these is not particularly limited. It is preferable to select water-dispersible resins appropriately according to the film elongations or the like thereof. For example, the mass ratio of a water-dispersible resin having a film elongation of 400% or more to a water-dispersible resin having a film elongation of less than 400% is preferably within a range from 9:1 to 3:7 and more preferably 4:1 to 2:3.

The amount of the water-dispersible resin having a film elongation of 400% or more is, relative to the total mass of the ink, preferably 1% by mass or more, and more preferably 2% by mass or more. The amount of the water-dispersible resin having a film elongation of 400% or more is, relative to the total mass of the ink, preferably 15% by mass or less, more preferably 10% by mass or less, and even more preferably 8% by mass or less. The amount of the water-dispersible resin having a film elongation of 400% or more is, relative to the total mass of the ink, preferably within a range from 1 to 15% by mass, more preferably 2 to 10% by mass, and even more preferably 2 to 8% by mass, for example.

The amount of the water-dispersible resin having a film elongation of less than 400% is, relative to the total mass of ink, preferably 1% by mass or more, more preferably 2% by mass or more, and even more preferably 3% by mass or more. The amount of the water-dispersible resin having a film elongation of less than 400% is, relative to the total mass of ink, preferably 20% by mass or less, more preferably 15% by mass or less, and even more preferably 10% by mass or less. The amount of the water-dispersible resin having a film elongation of less than 400% is, relative to the total mass of the ink, preferably within a range from 1 to 20% by mass, more preferably 2 to 15% by mass, and even more preferably 3 to 10% by mass, for example.

The amount of the water-dispersible resin having a film elongation of 400% or more is, relative to the total mass of the water-dispersible resin in the ink, preferably 30% by mass or more, more preferably 35% by mass or more, and even more preferably 40% by mass or more. The amount of the water-dispersible resin having a film elongation of 400% or more is, relative to the total mass of the water-dispersible resin in the ink, preferably 90% by mass or less, more preferably 85% by mass or less, and even more preferably 80% by mass or less. The amount of the water-dispersible resin having a film elongation of 400% or more is, relative to the total mass of the water-dispersible resin in the ink, preferably within a range from 30 to 90% by mass, more preferably 35 to 85% by mass, and even more preferably 40 to 80% by mass.

The amount of the water-dispersible resin having a film elongation of 400% or less is, relative to the total mass of the water-dispersible resin in the ink, preferably 10% by mass or more, more preferably 15% by mass or more, and even more preferably 20% by mass or more. The mount of the water-dispersible resin having a film elongation of 400% or less is, relative to the total mass of the water-dispersible resin in the ink, preferably 70% by mass or less, more preferably 65% by mass or less, and even more preferably 60% by mass or less. The amount of the water-dispersible resin having a film elongation of 400% or less is, relative to the total mass of the water-dispersible resin in the ink, preferably within a range from 10 to 70% by mass, more preferably 15 to 65% by mass, and even more preferably 20 to 60% by mass.

The aqueous pigment ink for textile inkjet printing preferably contains water, and the main solvent may be water.

The water is not particularly limited but preferably contains as few ionic components as possible. In particular, from the viewpoint of storage stability of the ink, it is preferable that the amount of polyvalent metal ions, such as calcium, be low. As the water, ion-exchanged water, distilled water, ultrapure water, or the like may be used, for example.

From the viewpoint of adjusting ink viscosity, water is preferably contained within a range from 25 to 80% by mass, more preferably 30 to 85% by mass, and even more preferably 35 to 80% by mass, relative to the total mass of the ink.

It is preferable to blend a water-soluble organic solvent into the aqueous pigment ink for textile inkjet printing. Any organic compound that is liquid at room temperature and can be dissolved in water can be used as the water-soluble organic solvent, and it is preferable to use a water-soluble organic solvent that mixes uniformly with an equal volume of water at 1 atmosphere and 20° C. Examples of organic solvents that may be used include lower alcohols such as methanol, ethanol, 1-propanol, isopropanol, 1-butanol, 2-butanol, isobutanol, and 2-methyl-2-propanol; glycols such as ethylene glycol, diethylene glycol, triethylene glycol, tetraethylene glycol, polyethylene glycol, propylene glycol, dipropylene glycol, tripropylene glycol, and polypropylene glycol; glycerols such as glycerol, diglycerol, triglycerol, and polyglycerol; acetins such as monoacetin and diacetin; glycol ethers such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; and triethanolamine, 1-methyl-2-pyrrolidone, 1,3-dimethyl-2-imidazolidinone, β-thiodiglycol, and sulfolane. The boiling point of the water-soluble organic solvent is preferably 100° C. or higher, and more preferably 150° C. or higher.

As the water-soluble organic solvent, it is preferable to use a solvent having high dryness and having a boiling point that is not very high. The boiling point of such a water-soluble organic solvent is preferably 250° C. or lower and more preferably 220° C. or lower. Examples of a water-soluble organic solvent having a boiling point of 250° C. or lower include ethylene glycol (boiling point 197° C.), 1,2-butanediol (boiling point 194° C.), 1,3-butanediol (boiling point 207° C.), 2-methyl-,3-propanediol (boiling point 214° C.), and diethylene glycol (boiling point 244° C.).

One water-soluble organic solvent may be used alone, or a combination of two or more can be used as long as a single phase is formed with water. The amount of the water-soluble organic solvent in the ink is, relative to the total mass of the ink, preferably within a range from 5 to 50% by mass, and more preferably 10 to 35% by mass.

The amount of the water-soluble organic solvent having a boiling point of 250° C. or lower is, relative to the total mass of the water-soluble organic solvent in the ink, preferably 20% by mass or more, more preferably 40% by mass or more, even more preferably 60% by mass or more, and even more preferably 70% by mass or more. The amount of the water-soluble organic solvent having a boiling point of 250° C. or lower may be, for example, 99% by mass or less, 90% by mass or less, or 80% by mass or less, relative to the total mass of the water-soluble organic solvent in the ink. For example, the amount of the water-soluble organic solvent having a boiling point of 250° C. or lower is preferably within a range from 20 to 99% by mass, more preferably 40 to 99% by mass, even more preferably 60 to 90% by mass, and even more preferably 70 to 80% by mass.

The amount of the water-soluble organic solvent having a boiling point of 250° C. or lower is, relative to the total mass of the ink, preferably 2% by mass or more, more preferably 5% by mass or more, and even more preferably 10% by mass or more. The amount of the water-soluble organic solvent having a boiling point of 250° C. or lower is, relative to the total mass of the ink, preferably 40% by mass or less, more preferably 30% by mass or less, and even more preferably 20% by mass or less. The amount of the water-soluble organic solvent having a boiling point of 250° C. or lower is, relative to the total mass of the ink, preferably within a range from 2 to 40% by mass, more preferably 5 to 30% by mass, and even more preferably 10 to 20% by mass, for example.

The aqueous pigment ink for textile inkjet printing preferably contains a crosslinking agent.

Examples of the crosslinking agent include carbodiimide-based compounds, isocyanate-based compounds, and oxazoline-based compounds.

Examples of commercial available products of the carbodiimide-based compounds include “CARBODILITE V-02” manufactured by Nisshinbo Chemical Inc. Examples of commercially available products of the isocyanate-based compounds include “TAKENATE WB-3021” manufactured by Mitsui Chemicals, Inc. Examples of commercially available products of the oxazoline-based compounds include “EPOCROS K2020E” manufactured by Nippon Shokubai Co., Ltd.

One crosslinking agent may be used alone, or a combination of two or more may be used. The amount of the crosslinking agent is, relative to the total mass of the ink, preferably 0.01% by mass or more, and more preferably 0.1% by mass or more. The amount of the crosslinking agent is, relative to the total mass of the ink, preferably 2% by mass or less, and more preferably 1% by mass or less. The amount of the crosslinking agent is, relative to the total mass of the ink, preferably within a range from 0.01 to 2% by mass, and more preferably 0.1 to 1% by mass.

The aqueous pigment ink for textile inkjet printing preferably contains a surfactant.

As the surfactant, an anionic surfactant, a cationic surfactant, an amphoteric surfactant, a nonionic surfactant, or a combination thereof can be preferably used, and a nonionic surfactant is more preferable. Either a low-molecular-weight surfactant or a high-molecular weight surfactant can be used.

An HLB value of the surfactant is preferably within a range from 5 to 20, and more preferably 10 to 18.

Examples of the nonionic surfactant include ester-based surfactants such as glycerol fatty acid esters and fatty acid sorbitan esters; ether-based surfactants such as polyoxyethylene alkyl ethers, polyoxyethylene alkylphenyl ethers, and polyoxypropylene alkyl ethers; ether-ester-based surfactants such as polyoxyethylene sorbitan fatty acid esters; acetylene-based surfactants; silicone-based surfactants; and fluorine-based surfactants. Among these, for example, acetylene-based surfactants such as acetylene glycol-based surfactants can be preferably used.

Examples of the acetylene-based surfactants include acetylene glycol-based surfactants, acetylene alcohol-based surfactants, and surfactants having an acetylene group.

Acetylene glycol-based surfactants are glycols having an acetylene group, are preferably glycols having a left-right symmetrical structure with an acetylene group in the center, and may include a structure in which ethylene oxide has been added to acetylene glycol.

Examples of commercially available products of acetylene-based surfactants include the SURFYNOL series of products such as “SURFYNOL 104E”, “SURFYNOL 104H”, “SURFYNOL 420”, “SURFYNOL 440”, “SURFYNOL 465”, and “SURFYNOL 485” manufactured by Evonik Industries AG, and the OLFINE series of products such as “OLFINE E1004”, “OLFINE E1010”, and “OLFINE E1020” manufactured by Nissin Chemical Industry Co., Ltd. (wherein all of the above are trade names).

Examples of the silicone-based surfactants include polyether-modified silicone-based surfactants, alkyl-aralkyl-comodified silicone-based surfactants, and acrylic silicone-based surfactants.

Examples of commercially available products of silicone-based surfactants include “SILFACE SAG002” and “SILFACE 503A” manufactured by Nissin Chemical Industry Co., Ltd. (both trade names).

Further examples of other nonionic surfactants include polyoxyethylene alkyl ether-based surfactants such as the EMULGEN series of products including “EMULGEN 102KG”, “EMULGEN 103”, “EMULGEN 104P”, “EMULGEN 105”, “EMULGEN 106”, “EMULGEN 108”, “EMULGEN 120”, “EMULGEN 147”, “EMULGEN 150”, “EMULGEN 220”, “EMULGEN 350”, “EMULGEN 404”, “EMULGEN 420”, “EMULGEN 705”, “EMULGEN 707”, “EMULGEN 709”, “EMULGEN 1108”, “EMULGEN 4085”, and “EMULGEN 2025G” manufactured by Kao Corporation (all trade names).

Examples of the anionic surfactants include the EMAL series of products such as “EMAL 0”, “EMAL 10”, “EMAL 2F”, “EMAL 40”, and “EMAL 20C”, the NEOPELEX series of products such as “NEOPELEX GS”, “NEOPELEX G-15”, “NEOPELEX G-25”, and “NEOPELEX G-65”, the PELEX series of products such as “PELEX OT-P”, “PELEX TR”, “PELEX CS”, “PELEX TA”, “PELEX SS-L”, and “PELEX SS-H”, and the DEMOL series of products such as “DEMOL N”, “DEMOL NL”, “DEMOL RN”, and “DEMOL MS”, all manufactured by Kao Corporation (all trade names).

Examples of the cationic surfactants include the ACETAMIN series of products such as “ACETAMIN 24” and “ACETAMIN 86”, the QUARTAMIN series of products such as “QUARTAMIN 24P”, “QUARTAMIN 86P”, “QUARTAMIN 60W”, and “QUARTAMIN 86W”, and the SANISOL series of products such as “SANISOL C” and “SANISOL B-50”, all manufactured by Kao Corporation (all trade names).

Examples of the amphoteric surfactants include the AMPHITOL series of products such as “AMPHITOL 20BS”, “AMPHITOL 24B”, “AMPHITOL 86B”, “AMPHITOL 20YB”, and “AMPHITOL 20N” manufactured by Kao Corporation (all trade names).

One of the above surfactants is preferably used alone, but a combination of two or more surfactants may also be used.

The amount of the surfactant is, relative to the total mass of the ink, preferably within a range from 0.01 to 10% by mass, more preferably 0.1 to 5% by mass, and even more preferably 0.2 to 3% by mass.

The aqueous pigment ink for textile inkjet printing may contain one or more other components as necessary. Examples of other components include pH adjusters and preservatives.

There are no particular limitations on the method for producing the aqueous pigment ink for textile inkjet printing, and production can be performed using appropriate conventional methods. For example, the ink can be obtained using a stirring device such as a overhead stirrer to disperse all of the components, either in a single batch or in a number of separate batches, and then passing the dispersion through a filtration device such as a membrane filter if desired.

From the viewpoint of improving the washing fastness, the weight change ratio between before and after immersion in warm water at 50° C. of the ink film produced by drying the ink is preferably 20% or less, more preferably 15% or less, and even more preferably 10% or less.

The weight change ratio between before and after immersion in warm water at 50° C. of the ink film produced by drying the ink may be, for example, 0%, more than 0%, 0.1% or more, or 1% or more.

The weight change ratio between before and after immersion in warm water at 50° C. of the ink film produced by drying the ink may be within a range from 0 to 20%, 0.1 to 15%, or 1 to 15%, for example.

The weight change ratio between before and after immersion in warm water at 50° C. of the ink film produced by drying the ink can be obtained as follows.

First, the ink is applied on a polytetrafluoroethylene sheet in an amount sufficient to achieve a dried film thickness of 200 μm, and the applied ink is then dried at 70° C. for 60 minutes, then at 120° C. for 20 minutes, and then at 160° C. for 10 minutes, and the resulting film is then detached from the sheet to produce an ink film. Drying conditions are not limited to those described above as long as a smooth and homogeneous ink film can be made with no mixing of bubbles due to boiling of the ink and at a temperature close to the maximum temperature to be applied to the actual printed item.

The ink film produced as described above is punched out using a dumbbell-type test piece punching blade No. 8 according to JIS K6251 to produce a test piece.

After the weight (A) of the produced test piece is measured, the test piece is immersed in warm water at 50° C., is held in the warm water for 24 hours, and then is taken out from the water. Then, after water droplets on the test piece are wiped off, the test piece is dried in a thermostatic chamber (23° C., 50%) for 2 hours, and then the weight (B) of the test piece is measured. The weight change ratio between before and after immersion in warm water at 50° C. can be obtained based on the equation below using the weight (A) of the test piece before immersion and the weight (B) of the test piece after immersion measured as described above.

Weight change ratio (%) between before and after immersion in warm water at 50° C.={(B−A)/A}×100

The weight change ratio between before and after immersion in warm water at 50° C. of the ink film produced by drying the ink can be adjusted by, for example, adjusting the density of the ink film. For example, the weight change ratio between before and after immersion in warm water at 50° C. can be reduced by increasing the density of the ink film and increasing the water resistance of the ink film. Examples of a method for increasing the density of the ink film include reducing the amount of a water-soluble organic solvent having a high boiling point and using a water-soluble organic solvent having a low boiling point instead to increase the dryness, and blending a crosslinking agent into the ink. One of these methods may be used alone, or two or more may be used in combination.

From the viewpoint of improving elasticity to withstand stretching of the fabric during washing and thus improving washing fastness, the film elongation after immersion in warm water at 50° C. of the ink film produced by drying the ink is preferably 300% or less, preferably 250% or less, and even more preferably 200% or less. From the viewpoint of improving the ease with which the ink film follows the stretching of the fabric during washing and thus improving washing fastness, the film elongation after immersion in warm water at 50° C. of the ink film produced by drying the ink is preferably 50% or more, more preferably 70% or more, and even more preferably 100% or more. The film elongation after immersion in warm water at 50° C. of the ink film produced by drying the ink is preferably within a range from 50 to 300%, more preferably 70 to 250%, and even more preferably 100 to 200%.

The film elongation after immersion in warm water at 50° C. of the ink film produced by drying the ink can be measured according to the following procedure. First, an ink film can be produced using the method for producing an ink film described in the measurement of the weight change ratio between before and after immersion in warm water at 50° C. of the ink film produced by drying the ink. The ink film produced as described above is punched out using a dumbbell-type test piece punching blade No. 8 according to JIS K6251 to produce a test piece.

Using a tensile tester, under the conditions of a measurement temperature of 20° C., a measurement speed of 500 mm/min, a chuck separation distance of 20 mm, and a load cell load of 50N, a test piece produced as described above is stretched and the length L_{1F} to which the test piece is stretched until the test piece breaks (also referred to as the “test piece length after stretching”) is measured, and using the length L_{1F0} of the test piece before stretching and the length L_{1F} of the test piece after stretching, the film elongation (%) can be obtained using the following equation.

Film elongation (%)={(L_{IF}−L_{IF0})/L_{IF0}}×100

As the tensile tester, a Tensilon Universal Tester RTC-1225A (manufactured by Orientec Co., Ltd.) can be used.

The film elongation after immersion in warm water at 50° C. of the ink film produced by drying the ink can be adjusted by, for example, the type, combination, and blend ratio of water-dispersible resins. For example, it is preferable to use two or more water-dispersible resins having different film elongations. The blend ratio of two or more water-dispersible resins having different film elongations is preferably selected in consideration of the film elongation of each resin. It is preferable to adjust the film elongation of the ink film in consideration of the fact that the film elongation tends to be lower by immersion in warm water than that before immersion in warm water.

The pH of the aqueous pigment ink for textile inkjet printing is preferably within a range from 7.0 to 10.0 and more preferably 7.5 to 9.0 from the viewpoint of storage stability of the ink.

The viscosity of the aqueous pigment ink for textile inkjet printing is preferably within a range from 1 to 30 mPa·s at 23° C.

The aqueous pigment ink for textile inkjet printing according to one embodiment can be preferably used for printing on a fabric.

Examples of fibers contained in a fabric are natural fibers such as cotton, silk, wool, and hemp, and chemical fibers such as polyester, acrylic, polyurethane, nylon, rayon, cupra, and acetate. The fabric may contain one type or two or more types of fibers. The fabric may be, for example, a woven fabric, a knitted fabric, or a non-woven fabric.

### <Method for Producing Printed Textile Item>

A method for producing a printed textile item using an aqueous pigment ink for textile inkjet printing according to one embodiment will be described below.

The method for producing a printed textile item according to one embodiment can include applying an aqueous pigment ink for textile inkjet printing to a fabric using an inkjet method. As the aqueous pigment ink for textile inkjet printing, the aqueous pigment ink for textile inkjet printing according to one embodiment described above can be used. As the fabric, it is possible to use a fabric described above for which the aqueous pigment ink for textile inkjet printing according to one embodiment described above is usable.

The ink is preferably applied to a fabric using an inkjet method. The inkjet method is not particularly limited and may be any method such as a piezo method, an electrostatic method, or a thermal method. When an inkjet printer is used, it is preferable for droplets of a pre-treatment liquid or an ink to be jetted from an inkjet head based on a digital signal to cause the jetted droplets to be attached to the fabric.

The amount of the ink applied to a fabric is not particularly limited, and is preferably within a range from 5 to 60 g/m² and more preferably 10 to 30 g/m², for example.

One type of ink may be applied to a fabric, or two or more types of ink may be applied to a fabric.

It is preferable to provide a process for heat-treating the fabric after the ink is applied to the fabric.

The heat-treatment temperature can be appropriately selected according to the material of the fabric and the like. The heat-treatment temperature is preferably 100° C. or higher and more preferably 150° C. or higher, for example. The heat-treatment temperature is preferably 200° C. or lower from the viewpoint of reducing damage to the fabric.

The heating device is not particularly limited, and a heat press, a roll heater, a hot air device, an infrared lamp heater, or the like can be used, for example.

The heat treatment time may be set appropriately according to the heating method and the like, and is preferably within a range from 1 second to 10 minutes and may be within a range from 5 seconds to 5 minutes, for example.

A pre-treatment liquid may be applied to the fabric before the ink is applied.

A post-treatment liquid may be applied to the fabric after the ink is applied to the fabric.

For example, the fabric may be heat-treated after a pre-treatment liquid is applied, and/or after the ink is applied, and/or the post-treatment liquid is applied.

### <Note>

This disclosure includes the following embodiments, but the present invention is not limited to these embodiments.
(1) An aqueous pigment ink for textile inkjet printing, including a pigment, a water-dispersible resin, water, and a water-soluble organic solvent, wherein an ink film made by drying the aqueous pigment ink for textile inkjet printing has a weight change ratio of 20% or less between before and after immersion in warm water at 50° C., and has a film elongation of 50% to 300% after immersion in warm water at 50° C.
(2) The aqueous pigment ink for textile inkjet printing according to the above (1), wherein the ink film has a weight change ratio of 10% or less between before and after immersion in warm water at 50° C.
(3) The aqueous pigment ink for textile inkjet printing according to the above (1) or (2), wherein the ink film has a film elongation of 100% to 200% after immersion in warm water at 50° C.
(4) A method for producing a printed textile item, including applying the aqueous pigment ink for textile inkjet printing according to any one of the above (1) to (3) to a fabric using an inkjet method.

### Examples

Embodiments of the present invention will be described in detail below using examples. The present invention is not limited to the following examples.

### 1. Preparation of Aqueous Pigment Ink for Textile Inkjet Printing

Tables 1 to 3 show ink formulations of examples 1 to 9 and comparative examples 1 to 5. The raw materials were mixed according to the formulations shown in Tables 1 to 3 and were filtered through a membrane filter having a pore size of 3 m to obtain inks. The unit of amount of each raw material shown in Tables 1 to 3 is % by mass. In Tables 1 to 3, the amounts of a pigment dispersion and a resin emulsion are each shown as the total amount including an aqueous medium and the like. CARBODILITE V-02 (trade name) and EPOCROS K2020E (trade name) in the tables also include an aqueous medium and the like, and their amounts are each shown as the total amount including an aqueous medium and the like. In Tables 1 to 3, “Ex 1” to “Ex 9” respectively represent “Example 1” to “Example 9”, and “C Ex 1” to “C Ex 6” respectively represent “Comparative Example 1” to “Comparative Example 6”.

Details of the raw materials in Tables 1 to 3 are as follows.

### (Pigment Dispersion)

CAB-O-JET400 (trade name): self-dispersing pigment dispersion (black) manufactured by Cabot Corporation, pigment content 15% by mass

### (Resin Emulsion)

SUPERFLEX 500M (trade name): polyurethane resin emulsion manufactured by DKS Co., Ltd., resin content 45% by mass, glass transition temperature (Tg): −39° C., film elongation: 1100%

SUPERFLEX 460 (trade name): polyurethane resin emulsion, manufactured by DKS Co., Ltd., resin content 38% by mass, glass transition temperature (Tg): −21° C., film elongation: 750%

DAOTAN TW6493/35WA (trade name): polyurethane resin emulsion manufactured by DaicelAllnex Ltd., resin content 33% by mass, glass transition temperature (Tg): 100° C., film elongation: 70%

ADEKA BONTIGHTER HUX-2520 (trade name): polyurethane resin emulsion, manufactured by ADEKA Corporation, resin content 32% by mass, film elongation: 5%

ADEKA BONTIGHTER HUX-841 (trade name): polyurethane resin emulsion, manufactured by ADEKA Corporation, resin content 32% by mass, film elongation: 210%

NeoCryl XK-12 (trade name): acrylic-based resin emulsion manufactured by Covestro AG, resin content 45% by mass resin, glass transition temperature (Tg): 21° C.

### (Crosslinking Agent)

CARBODILITE V-02 (trade name): carbodiimide-based compound manufactured by Nisshinbo Chemical Inc., active ingredient 40% by mass

EPOCROS K2020E (trade name): oxazoline-based compound, manufactured by Nippon Shokubai Co., Ltd., active ingredient 40% by mass

### (Surfactant)

OLFINE E1010 (trade name): acetylene glycol-based surfactant manufactured by Nissin Chemical Industry Co., Ltd., active ingredient 100% by mass

### (Water-Soluble Organic Solvent)

Glycerin: manufactured by FUJIFILM Wako Pure Chemical Corporation

Diethylene glycol: manufactured by FUJIFILM Wako Pure Chemical Corporation

### 2. Measurement of Film Elongation of Resin Emulsion

The film elongation of resin emulsions shown in the tables is obtained according to the following procedure.

First, a resin emulsion was applied on a polytetrafluoroethylene sheet in an amount sufficient to achieve a dried film thickness of 500 μm, and the applied resin emulsion was then dried at 23° C. for 15 hours, then at 80° C. for 6 hours, and then at 120° C. for 20 minutes, and the resulting film was then detached from the sheet to produce a resin film. This resin film was punched out using a dumbbell-type test piece punching blade No. 8 according to JIS K6251 to produce a test piece.

Using a Tensilon Universal Tester RTC-1225A (manufactured by Orientec Co., Ltd.), under the conditions of a measurement temperature of 20° C., a measurement speed of 500 mm/min, a chuck separation distance of 20 mm, and a load cell load of 50N, a test piece produced was stretched and the length L_{RF} to which the test piece was stretched until the test piece broke (also referred to as the “test piece length after stretching”) was measured, and using the length L_{RF0} of the test piece before stretching and the length L_{RF} of the test piece after stretching, the film elongation (%) was obtained using the following equation.

Elongation (%) {(L_{RF}−L_{RF0})/L_{RF0}}×100

### 3. Measurement of Weight Change Ratio of Ink Film Between Before and After Immersion in Warm Water at 50° C.

The weight change ratio of each ink film between before and after immersion in warm water at 50° C. described in the tables is a value obtained according to the following procedure.

First, an ink was applied on a polytetrafluoroethylene sheet in an amount sufficient to achieve a dried film thickness of 200 μm, and the applied ink was dried at 70° C. for 60 minutes, then at 120° C. for 20 minutes, and then at 160° C. for 10 minutes, and then the resulting film was then detached from the sheet to produce an ink film. This ink film was punched out using a dumbbell-type test piece punching blade No. 8 according to JIS K6251 to produce a test piece.

After the weight (A) of the produced test piece was measured, the test piece was immersed in warm water at 50° C., was held in the warm water for 24 hours, and then was taken out from the water. Then, after water droplets of the test piece were wiped off, the test piece was dried in a thermostatic chamber (23° C., 50%) for 2 hours, and then the weight (B) of the test piece was measured. The weight change ratio between before and after immersion in warm water at 50° C. was obtained based on the equation below using the weight (A) of the test piece before immersion and the weight (B) of the test piece after immersion as measured above.

Weight change ratio (%) between before and after immersion in warm water at 50° C.={(B−A)/A}×100

4. Measurement of Film Elongation of Ink Film after Immersion in Warm Water at 50° C.

The film elongation of ink film after immersion in warm water at 50° C. described in the tables is a value obtained according to the following procedure.

A test piece was produced using the same method used to produce a test piece in the measurement of the weight change ratio of ink film between before and after immersion in warm water at 50° C. described above.

Using a Tensilon Universal Tester RTC-1225A (manufactured by Orientec Co., Ltd.), under the conditions of a measurement temperature of 20° C., a measurement speed of 500 mm/min, a chuck separation distance of 20 mm, and a load cell load of 50N, a test piece produced was stretched and the length L_{IF} of the test piece after having been stretched until the test piece broke (also referred to as the “test piece length after stretching”) was measured, and using the length L_{IF0} of the test piece before stretching and the length L_{IF} of the test piece after stretching, the film elongation (%) was obtained using the following equation.

Film elongation (%) {(L_{IF}−L_{IF0})/L_{IF0}}×100

### 5. Production of Printed Textile Item

Printed textile items of examples 1 to 8 and comparative examples 1 to 5 were produced according to the following procedure using the ink produced above.

A cotton T-shirt manufactured by TOMS Co., Ltd. (trade name: Printstar) was used as a substrate, and an aqueous pigment ink for textile inkjet printing was applied on a 10 cm×20 cm portion of the surface of the cotton T-shirt using an inkjet method to print a black solid image thereon. The amount of applied ink was 20 g/m². An “MMP-8130” manufactured by Mastermind Co., Ltd. was used as a printer for the application of ink. After the application of ink, a printed textile item was obtained through heat drying at 160° C. for 2 minutes using a “Fusion heat press” manufactured by STAHLS' Hotronix.

### 6. Evaluation of Washing Fastness

The washing fastness of the printed textile items of examples 1 to 9 and comparative examples 1 to 5 was evaluated according to JIS L 844:2011, Standard A-2, and was judged according to the following criteria. The results are shown in Tables 1 to 3.
A: Discoloration grade 4 or higher
B: Discoloration grade 3-4
C: Discoloration grade 3 or lower

TABLE 1

| | | Resin | | | | | | |
|---|---|---|---|---|---|---|---|---|
| | | film | | | | | | |
| | | elonga- | Tg | | | | | |
| Raw material (% by mass) | | tion (%) | (° C.) | Ex 1 | Ex 2 | Ex 3 | Ex 4 | Ex 5 |
| Pigment | CAB-O-JET 400 | | | 26.7 | 26.7 | 26.7 | 26.7 | 26.7 |
| dispersion | (pigment content 15% by | | | | | | | |
| | mass) | | | | | | | |
| Resin | SUPERFLEX 500M | 1100 | −39 | 11.1 | 6.7 | 11.1 | 11.1 | 6.7 |
| emulsion | (resin content 45% by | | | | | | | |
| | mass) | | | | | | | |
| | SUPERFLEX 460 (resin | 750 | −21 | | | | | |
| | content 38% by mass) | | | | | | | |
| | DAOTAN TW | 70 | 100 | 15.2 | | | | |
| | 6493/35WA (resin | | | | | | | |
| | content 33% by mass) | | | | | | | |
| | ADEKA | 5 | | | 21.9 | 15.6 | 15.6 | |
| | BONTIGHTER HUX- | | | | | | | |
| | 2520 (resin content 32% | | | | | | | |
| | by mass) | | | | | | | |
| | ADEKA | 210 | | | | | | 21.9 |
| | BONTIGHTER HUX- | | | | | | | |
| | 841 (resin content 32% | | | | | | | |
| | by mass) | | | | | | | |
| | NeoCryl XK-12 (resin | | 21 | | | | | |
| | content 45% by mass) | | | | | | | |
| Cross- | CARBODILITE V-02 | | | | | | | |
| linking | (active ingredient 40% by | | | | | | | |
| agent | mass) | | | | | | | |
| | EPOCROS K2020E | | | | | | | |
| | (active ingredient 40% by | | | | | | | |
| | mass) | | | | | | | |
| Surfactant | OLFINE E1020 (active | | | 0.5 | 0.5 | 0.5 | 0.5 | 0.5 |
| | ingredient 100% by | | | | | | | |
| | mass) | | | | | | | |
| Water- | Glycerin (boiling point | | | 5.0 | 5.0 | 5.0 | 15.0 | 5.0 |
| soluble | 290° C.) | | | | | | | |
| organic | Ethylene glycol (boiling | | | 15.0 | 15.0 | 15.0 | 5.0 | 15.0 |
| solvent | point 197° C.) | | | | | | | |

| | | | | | |
|---|---|---|---|---|---|
| Water | 26.5 | 24.2 | 26.1 | 26.1 | 24.2 |
| Total (% by mass) | 100.0 | 100.0 | 100.0 | 100.0 | 100.0 |
| Weight change ratio of ink coating film between before | +3 | +2 | +2 | +12 | +8 |
| and after immersion in warm water at 50° C. (%) | | | | | |
| Film elongation of ink coating film after immersion in | 170 | 80 | 180 | 190 | 280 |
| warm water at 50° C. (%) | | | | | |
| Washing fastness | A | B | A | B | B |

TABLE 2

| | | Resin | | | | | |
|---|---|---|---|---|---|---|---|
| | | film | | | | | |
| | | elonga- | Tg | | | | |
| Raw material (% by mass) | | tion (%) | (° C.) | Ex 6 | Ex 7 | Ex 8 | Ex 9 |
| Pigment | CAB-O-JET 400 | | | 26.7 | 26.7 | 26.7 | 26.7 |
| dispersion | (pigment content 15% by | | | | | | |
| | mass) | | | | | | |
| Resin | SUPERFLEX 500M | 1100 | −39 | 11.1 | | | |
| emulsion | (resin content 45% by | | | | | | |
| | mass) | | | | | | |
| | SUPERFLEX 460 (resin | 750 | −21 | | 10.5 | 10.5 | 10.5 |
| | content 38% by mass) | | | | | | |
| | DAOTAN TW | 70 | 100 | | 18.2 | 18.2 | 18.2 |
| | 6493/35WA (resin | | | | | | |
| | content 33% by mass) | | | | | | |
| | ADEKA | 5 | | | | | |
| | BONTIGHTER HUX- | | | | | | |
| | 2520 (resin content 32% | | | | | | |
| | by mass) | | | | | | |
| | ADEKA | 210 | | | | | |
| | BONTIGHTER HUX- | | | | | | |
| | 841 (resin content 32% | | | | | | |
| | by mass) | | | | | | |
| | NeoCryl XK-12 (resin | | 21 | 11.1 | | | |
| | content 45% by mass) | | | | | | |
| Cross- | CARBODILITE V-02 | | | | | 0.5 | |
| linking | (active ingredient 40% by | | | | | | |
| agent | mass) | | | | | | |
| | EPOCROS K2020E | | | | | | 0.5 |
| | (active ingredient 40% by | | | | | | |
| | mass) | | | | | | |
| Surfactant | OLFINE E1020 (active | | | 0.5 | 0.5 | 0.5 | 0.5 |
| | ingredient 100% by | | | | | | |
| | mass) | | | | | | |
| Water- | Glycerin (boiling point | | | 5.0 | 5.0 | 5.0 | 5.0 |
| soluble | 290° C.) | | | | | | |
| organic | Ethylene glycol (boiling | | | 15.0 | 15.0 | 15.0 | 15.0 |
| solvent | point 197° C.) | | | | | | |

| | | | | |
|---|---|---|---|---|
| Water | 30.6 | 24.1 | 23.6 | 23.6 |
| Total (% by mass) | 100.0 | 100.0 | 100.0 | 100.0 |
| Weight change ratio of ink coating film between before | +4 | +18 | +3 | +3 |
| and after immersion in warm water at 50° C. (%) | | | | |
| Film elongation of ink coating film after immersion in | 160 | 190 | 160 | 110 |
| warm water at 50° C. (%) | | | | |
| Washing fastness | A | B | A | A |

TABLE 3

| | | Resin | | | | | | | |
|---|---|---|---|---|---|---|---|---|---|
| | | film | | | | | | | |
| | | elonga- | Tg | C Ex | C Ex | C Ex | C Ex | C Ex | C Ex |
| Raw material (% by mass) | | tion (%) | (° C.) | 1 | 2 | 3 | 4 | 5 | 6 |
| Pigment | CAB-O-JET 400 | | | 26.7 | 26.7 | 26.7 | 26.7 | 26.7 | 26.7 |
| dispersion | (Pigment content 15% by | | | | | | | | |
| | mass) | | | | | | | | |
| Resin | SUPERFLEX 500M | 1100 | −39 | 22.2 | | | | | 4.4 |
| emulsion | (resin content 45% by | | | | | | | | |
| | mass) | | | | | | | | |
| | SUPERFLEX 460 (resin | 750 | −21 | | 26.3 | 7.9 | | 25.0 | |
| | content 38% by mass) | | | | | | | | |
| | DAOTAN TW | 70 | 100 | | | | | | |
| | 6493/35WA (resin | | | | | | | | |
| | content 33% by mass) | | | | | | | | |
| | ADEKA | 5 | | | | 21.9 | | 1.6 | 25 |
| | BONTIGHTER HUX- | | | | | | | | |
| | 2520 (resin content 32% | | | | | | | | |
| | by mass) | | | | | | | | |
| | ADEKA | 210 | | | | | 31.3 | | |
| | BONTIGHTER HUX- | | | | | | | | |
| | 841 (resin content 32% | | | | | | | | |
| | by mass) | | | | | | | | |
| | NeoCryl XK-12 (resin | | 21 | | | | | | |
| | content 45% by mass) | | | | | | | | |
| Cross- | CARBODILITE V-02 | | | | | | | | |
| linking | (active ingredient 40% by | | | | | | | | |
| agent | mass) | | | | | | | | |
| | EPOCROS K2020E | | | | | | | | |
| | (active ingredient 40% by | | | | | | | | |
| | mass) | | | | | | | | |
| Surfactant | OLFINE E1020 (active | | | 0.5 | 0.5 | 0.5 | 0.5 | 0.5 | 0.5 |
| | ingredient 100% by | | | | | | | | |
| | mass) | | | | | | | | |
| Water- | Glycerin (boiling point | | | 5.0 | 5.0 | 5.0 | 5.0 | 5.0 | 5.0 |
| soluble | 290° C.) | | | | | | | | |
| organic | Ethylene glycol (boiling | | | 15.0 | 15.0 | 15.0 | 15.0 | 15.0 | 15.0 |
| solvent | point 197° C.) | | | | | | | | |

| | | | | | | |
|---|---|---|---|---|---|---|
| Water | 30.6 | 26.5 | 23.0 | 21.5 | 26.2 | 23.4 |
| Total (% by mass) | 100.0 | 100.0 | 100.0 | 100.0 | 100.0 | 100.0 |
| Weight change ratio of ink coating film between before | +46 | +25 | +32 | +40 | +8 | +7 |
| and after immersion in warm water at 50° C. (%) | | | | | | |
| Film elongation of ink coating film after immersion in | 820 | 620 | 70 | 220 | 320 | 40 |
| warm water at 50° C. (%) | | | | | | |
| Washing fastness | C | C | C | C | C | C |

All of the printed textile items of examples 1 to 9 had good washing fastness.

In contrast, comparative examples 1 and 2, in which the weight change ratio of the ink film between before and after immersion in warm water at 50° C. and the film elongation of the ink film after immersion in warm water at 50° C. were both too high, comparative examples 3 and 4, in which the weight change ratio of the ink film between before and after immersion in warm water at 50° C. was too high, comparative example 5, in which the film elongation of the ink film after immersion in warm water at 50° C. was too high, and comparative example 6, in which the film elongation of the ink film after immersion in warm water at 50° C. was too low, all exhibited a decrease in the washing fastness.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An aqueous pigment ink for textile inkjet printing, comprising: a pigment, a water-dispersible resin, water, and a water-soluble organic solvent, wherein
an ink film made by drying the aqueous pigment ink for textile inkjet printing has a weight change ratio of 20% or less between before and after immersion in warm water at 50° C., and has a film elongation of 50% to 300% after immersion in warm water at 50° C.

2. The aqueous pigment ink for textile inkjet printing according to claim 1, wherein the ink film has a weight change ratio of 10% or less between before and after immersion in warm water at 50° C.

3. The aqueous pigment ink for textile inkjet printing according to claim 1, wherein the ink film has a film elongation of 100% to 200% after immersion in warm water at 50° C.

4. A method for producing a printed textile item, comprising:
applying the aqueous pigment ink for textile inkjet printing according to claim 1 to a fabric using an inkjet method.

5. The method for producing a printed textile item according to claim 4, wherein the ink film has a weight change ratio of 10% or less between before and after immersion in warm water at 50° C.

6. The method for producing a printed textile item according to claim 4, wherein the ink film has a film elongation of 100% to 200% after immersion in warm water at 50° C.
